(19) United States
(12) Patent Application Publication
(10) Pub. No.: US 2006/0278831 A1
(43) Pub. Date: Dec. 14, 2006

(54) Infrared inspection apparatus, infrared inspecting method and manufacturing method of semiconductor wafer

(75) Inventors: Norihisa Matsumoto, Tokyo (JP); Shigeru Matsuno, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/447,997

(22) Filed: Jun. 7, 2006

(30) Foreign Application Priority Data
Jun. 14, 2005 (JP) 2005-173423

(51) Int. Cl. G01N 21/59

(52) U.S. Cl. 250/341.1

(57) ABSTRACT

An infrared inspection apparatus includes: an infrared light source operable to irradiate an inspection object with infrared rays; an infrared lens operable to collect infrared rays which have passed through the inspection object; an infrared camera operable to receive the infrared rays collected by the infrared lens and to convert the infrared rays received into an electric signal to be output; a monitor operable to receive the electric signal from the infrared camera and to convert the electric signal into an image signal and to display an image based on the image signal; and an infrared ray leakage preventing member in at least one of a light path between the infrared light source and a periphery of the inspection object and a light path between the periphery of the inspection object and the infrared lens to prevent infrared rays from the infrared light source from reaching the infrared lens without passing through the inspection object.

This application is based on Japanese Patent Application No. 2005-173423 filed in Japan on Jun. 14, 2005, the contents of which are hereby incorporated by reference.

### BACKGROUND OF THE INVENTION

1. Field of the Invention

The present invention relates to an infrared inspection apparatus which irradiates an inspection object with infrared rays and observes the infrared rays that passed through the inspection object to inspect the inspection object, and more particularly to an infrared inspection apparatus for a semiconductor wafer in which a semiconductor wafer is used as the inspection object.

2. Description of the Related Art

Conventionally, a semiconductor wafer inspection apparatus which detects a fine crack of a semiconductor wafer by irradiating the semiconductor wafer as the inspection object with infrared rays and observing the transmitted or reflected infrared rays has been developed. The Japanese Patent Laid-open Publication No.6-308042 discloses one of such semiconductor wafer inspection apparatus. According to the semiconductor wafer inspection apparatus in the Japanese Patent Laid-open Publication No. 6-308042, an infrared scattering light appropriately created is inputted first to a semiconductor silicon wafer which is an inspection object. Since the silicon wafer includes a single-crystalline silicon, it uniformly reflects the infrared scattering light, so that an infrared image is formed uniformly on a monitor based on the reflected light in general. However, since a crack part in the semiconductor silicon wafer reflects the infrared scattering light unlike the silicon single-crystalline part, the crack part appears as shadow in an infrared image formed based on the reflected light. Thus, the fine crack of the semiconductor silicon wafer can be detected by observing the shadow image on the monitor.

In addition, the Japanese Patent Laid-open Publication No. 2000-65760 discloses an apparatus and a method of detecting a defect of a substrate. According to the apparatus and the method, an object to be measured is irradiated with uniform infrared rays from an infrared light source arranged in a ring shape, and reflected light from the object is detected in its center part. An infrared inspection apparatus disclosed in the Japanese Patent Laid-open Publication No. 8-220008 inspects a defect of a semiconductor wafer and the like using infrared rays. According to the infrared inspection apparatus, it is not considered that the infrared rays are prevented from being directly inputted from an infrared light source without passing through an inspection object. The Japanese Patent Laid-open Publication No. 2002-26096 discloses a quality evaluating method and a reproducing method of a silicon wafer. According to the method, the silicon wafer is analyzed with infrared absorption spectrum and its quality is evaluated based on a ratio of absorbance. According to this quality evaluation method, it is not considered that the infrared rays are prevented from being directly inputted from an infrared light source without passing through an inspection object. The Japanese Patent Laid-open Publication No. 8-304298 discloses an apparatus which inspects a defect with an infrared camera while applying a current to an inspection object. According to the apparatus, a heat spot is generated at a defect part by applying the current to the inspection object, and the defect part is detected by monitoring a bright point of the infrared rays at this part. Although an embodiment for avoiding an adverse affect applied to the inspection object due to heat emitted from the light source is described in the Japanese Patent Laid-open Publication No. 8-304298, it does not relates to a method of actively reducing an amount of infrared rays directly applied to the inspection object.

According to the above conventional techniques, when the inspection object is irradiated with the infrared rays and the infrared rays which passed through the inspection object are observed to inspect the defect part (cracked part) at an end part of the inspection object, there is a case where a contrast ratio of an infrared image cannot be provided so that observation cannot be made. This phenomenon arises because the infrared rays leaking from the end part of the inspection object are inputted to the infrared camera directly and intensity of the leaking infrared rays is higher than that of the infrared rays which passed through the inspection object.

### SUMMARY OF THE INVENTION

It is an object of the present invention to provide an infrared inspection apparatus which can appropriately detect a fine defect part especially at an end part of an inspection object when a defect part of the inspection object is detected by irradiating the inspection object with infrared rays and observing the transmitted infrared rays.

An infrared inspection apparatus according to the present invention includes an infrared light source operable to irradiate an inspection object with infrared rays; an infrared lens operable to collect the infrared rays which passed through the inspection object; an infrared camera operable to receive the infrared rays collected by the infrared lens and converting it to an electric signal to be outputted; a monitor operable to receive the electric signal from the infrared camera and converting it to an image signal and displaying an image based on the image signal; and an infrared ray leakage preventing member provided on at least one of a light path between the infrared light source and a periphery of the inspection object and a light path between the periphery of the inspection object and the infrared lens to prevent the infrared rays from the infrared light source from reaching the infrared lens without passing through the inspection object.

The infrared inspection apparatus according to the present invention can appropriately and clearly grasp a normal part and a defect part at an end part of the inspection object.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a block diagram showing a constitution of a semiconductor wafer inspection apparatus according to first embodiment of the present invention;

FIG. 2 is a block diagram showing a constitution of a semiconductor wafer inspection apparatus according to second embodiment of the present invention; and

FIG. 3 is a schematic view showing a position relation between a slit and an inspection object in the semiconductor wafer inspection apparatus according to the second embodiment of the present invention.

### DESCRIPTION OF THE PREFERRED EMBODIMENTS

A preferred embodiment of the present invention will be described with reference to the drawings hereinafter. In addition, although a semiconductor wafer inspection apparatus which inspects a semiconductor wafer is illustrated in the following description as an example of an infrared inspection apparatus in the present invention, an infrared inspection apparatus according to the present invention can be applied to an inspection apparatus which inspects an object other than the semiconductor wafer. Furthermore, the same reference numerals are allotted to the same components substantially.

(First Embodiment)

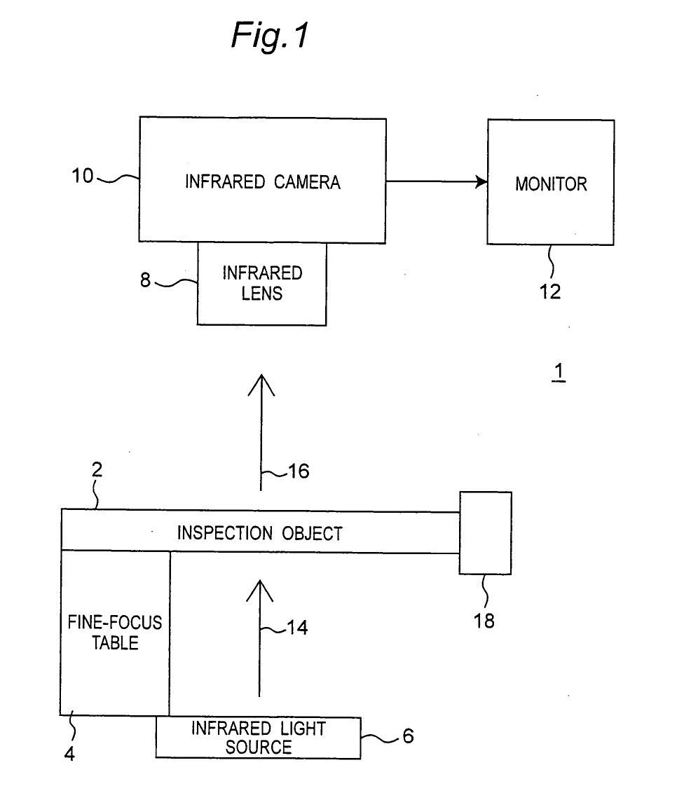

FIG. 1 is a block diagram showing a constitution of a semiconductor wafer inspection apparatus 1 according to first embodiment of the present invention. According to the semiconductor wafer inspection apparatus 1 in the first embodiment, a polycrystalline silicon substrate can be used as an inspection object 2, for example. The inspection object 2 is supported by a fine-focus table 4 and its horizontal and vertical positions can be determined by it. An infrared light source 6 is a light source to irradiate the inspection object 2 with infrared rays and may be a halogen lamp which can emit infrared rays, for example. A filter which can cut a visible light may be provided in front of the infrared light source 6 in order to make an image on a monitor 12 that will be described below clear. An infrared camera 10 including an infrared lens 8 collects the infrared rays from the inspection object 2 and converts the infrared rays to an electric signal and transmits the electric signal to the monitor 12 connected to the infrared camera 10. The monitor 12 receives the electric signal from the infrared camera 10 and displays an image taken by the infrared camera 10. A guide 18 is provided so as to be in contact with the inspection object 2 over its whole peripheral part. The guide 18 blocks off a light path between an end part of the inspection object 2 and the infrared lens 8. That is, the infrared rays from the infrared light source 6 provided under the inspection object 2 is prevented from leaking from an end part of the inspection object 2 and reaching the infrared lens because of the guide 18. Since the guide 18 is in contact with the inspection object 2, it is preferably formed of a soft material so that the inspection object 2 may not be damaged. More specifically, the guide 18 is preferably softer than the inspection object 2. In addition, the guide 18 is preferably formed of a material which does not transmit the infrared rays having wavelength 0.8 to 2 μm. Here, as the guide 18, an electrically conductive sponge in which carbon is mixed, which satisfies the above condition is used.

Next, a description will be made of a whole operation of the semiconductor wafer inspection apparatus 1.

One surface of the inspection object 2 is irradiated with the infrared rays 14 emitted from the infrared light source 6. Since the inspection object 2 is supported by the fine-focus table 4, the inspection object 2 can be brought to an appropriate position with respect to the infrared light source 6 and the infrared camera 10 by appropriately operating the fine-focus table 4. A relative distance between the infrared lens 8 provided with the infrared camera 10 and the infrared camera 10 is set by operating means in the infrared camera 10. Therefore, the infrared camera 10 can focus on the inspection object 2 by appropriately moving inspection object 2 and the infrared lens 8 in parallel on a line connecting the infrared light source 6 and the infrared camera 10. The inspection object 2 transmits the infrared rays 14 emitted from the infrared light source 6. The infrared rays after passed through the inspection object 2 is referred to as the “transmitted infrared rays 16” hereinafter. Then, the transmitted infrared rays 16 forms an image of the inspection object 2 on a light-receiving element in the infrared camera 10 with the infrared lens 8. The infrared camera 10 converts the image of the inspection object 2 to an electric signal and then converts it to a specific video signal through signal processing such as amplification and transmits it to the monitor 12 connected to the infrared camera 10. The monitor 12 receives the video signal and converts it to an image to be displayed.

Next, a description will be made of a role of the guide 18 and its operation.

In a case where the inspection object 2 is a polycrystalline silicon substrate, a fine crack (a defect part) exists in the substrate in some cases. The semiconductor wafer inspection apparatus 1 specifies the defect part by using a difference in transmitted state of the infrared rays between the defect part and the normal part. The difference in transmitted state of the infrared rays between the defect part and the normal part will be described hereinafter. First, the polycrystalline silicon substrate transmits the infrared rays having wavelengths of about 0.8 to 2 μm. Here, since the substrate is polycrystalline, although there is a slight difference in transmission factor depending on its crystal plain orientation, the silicon substrate transmits a certain amount of infrared rays. Therefore, an infrared image of the silicon substrate is a uniform image. Meanwhile, when the silicon substrate has the defect part such as the crack, the transmitted state of the infrared rays is different from the normal part in the polycrystalline silicon substrate. This difference is captured by the infrared camera 10 as a shadow part. The semiconductor wafer inspection apparatus 1 specifies the position of the defect part with reference to a contrast ratio of the normal part to the shadow part in the infrared image. However, when the direct infrared rays 14 and the transmitted infrared rays 16 passed through the inspection object 2 are inputted to the infrared lens 8, since the direct infrared rays 14 which was directly inputted from the infrared light source 6 is stronger than the transmitted infrared rays 16, the transmitted infrared rays 16 cannot be identified enough. Therefore, the whole image is bright, so that the defect part cannot be identified. Thus, according to the infrared inspection apparatus 1, the guide 18 is provided so as to be in contact with the entire periphery of the inspection object 2 as a member for preventing the infrared rays from leaking. Thus, the infrared rays 14 can be prevented from being directly inputted from the infrared light source 6 to the infrared lens 8, so that the infrared rays can be prevented from leaking from the outside of the end part of the inspection object 2. As a result, since the contrast ratio of the defect part to the other part can be sufficiently provided with the transmitted infrared rays 16, the position of the defect part can be specified.

The guide 18 is movable and set so as to be in closely contact with the end part of the inspection object 2 after the inspection object 2 is set on the fine-focus table 4 according to its size. At this time, it is necessary to be careful such that a new crack and the like may not be generated when the guide 18 abuts on the inspection object 2.

In addition, according to the semiconductor wafer inspection apparatus 1 in the first embodiment, it is assumed that an inspector carries out the inspection by checking the monitor 12 with eyes. Here, as another method, an appropriate computer program may be created to analyze the video signal outputted from the infrared camera 10, the infrared camera 10 or the monitor 12 may be connected to an appropriate computer, the computer program may be stored in a memory of the computer, and the computer may analyze the video signal to automatically analyze the defect part of the silicon substrate.

In addition, the guide 18 may be set so as to be in contact with only a part of the periphery of the inspection object 2.

Furthermore, in a case where the infrared lens 8 and the infrared camera 10 can collect a visible light and convert it to an electric signal (that is, the infrared lens 8 and the infrared camera 10 have a function to take an image of the visible light), the position of the defect part can be specified with high precision by taking the image of the visible light and the infrared rays in which the visible light is cut at the same time and displaying them to be compared on the monitor 12.

(Second Embodiment)

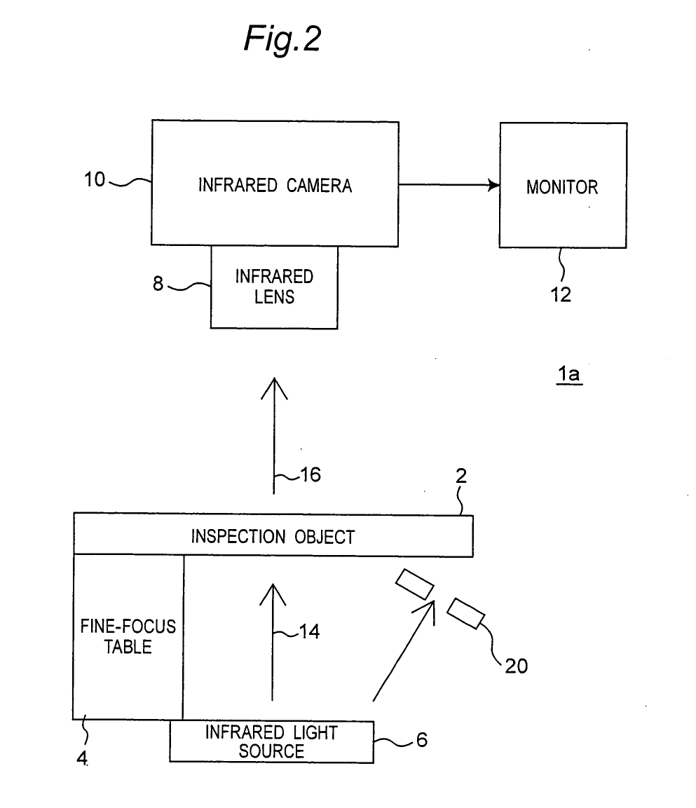

FIG. 2 is a block diagram showing a constitution of a semiconductor wafer inspection apparatus 1a according to second embodiment of the present invention. The semiconductor wafer inspection apparatus 1a is different from the semiconductor wafer inspection apparatus 1 according to the first embodiment in that a slit 20 is provided on a light path between an infrared light source and an periphery of a semiconductor wafer instead of the guide provided on the periphery of the semiconductor wafer as the infrared ray leakage preventing member. In addition, the same reference numerals are allotted to the same component substantially and their descriptions will be omitted.

As shown in FIG. 2, according to the second embodiment, when an end part of an inspection object 2 is observed, infrared rays 14 is applied from the infrared light source through the slit 20. The slit 20 blocks off a light path between the infrared light source 6 and a periphery of the inspection object 2. Since the irradiation direction of the infrared rays 14 is limited due to the slit 20, the infrared rays 14 from the infrared light source 6 cannot be directly inputted to an infrared lens 8.

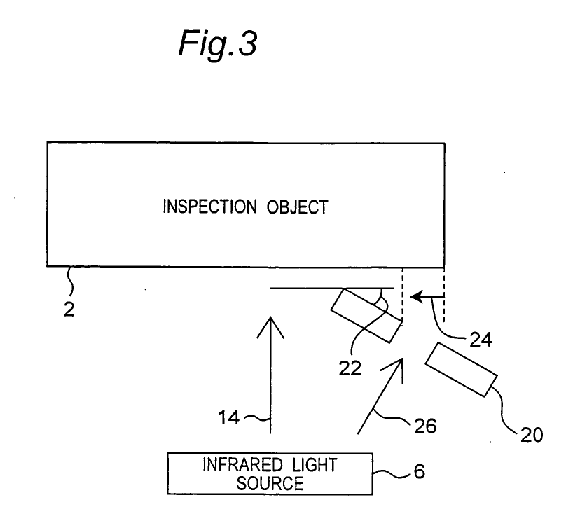

FIG. 3 is an enlarged schematic view showing an angle of the slit 20 to prevent the infrared rays 14, and a positional relation between the inspection object 2 and the slit 20. One end of the slit 20 has to be surely positioned inside the end part of the inspection object 2 (a slit position 24) to prevent the infrared rays 14 from directly reaching the infrared lens 8 from the infrared light source 6. Furthermore, an angle formed between the slit 20 and the inspection object 2 (slit angle 22) has to be positioned under a horizontal surface of the inspection object 2, which is the most important. Although the above parameters have to be set optimally depending on the positions of the inspection object 2 and the infrared light source 6 and an opening width of the slit 20 and the like, here they are set such that the opening width of the slit 20 is 10 mm, the slip position 24 is 5 mm from the substrate end, and the slit angle 22 is 30 degrees, for example. Thus, since the infrared rays 14 from the infrared light source 6 is prevented from being directly inputted to the infrared lens 8 without passing through the inspection object 2, the contrast ratio of the defect part to the normal part can be sufficiently provided with the transmitted infrared rays 16, and the position of the defect part can be specified.

In addition, although the guide 18 is not shown in FIG. 2, the guide 18 may be additionally provided so as to be in contact with the inspection object 2 in the semiconductor inspection apparatus 1 in the second embodiment.

(Third Embodiment)

Third embodiment is shown when the semiconductor wafer inspection apparatus shown in the first embodiment is used in a manufacturing process of a semiconductor wafer.

A semiconductor wafer having a defect part such as a crack and a semiconductor wafer having no defect can be discriminated by the inspection apparatus and the inspecting method shown in the first embodiment.

When the semiconductor wafer having the defect part such as the crack is put in a semiconductor wafer manufacturing equipment, the crack part is enlarged due to transportation or a heat treatment at the time of manufacturing steps, and the substrate is cracked into a plurality of parts in some cases. When the substrate is cracked, a defect of the equipment is generated and the equipment has to be stopped until the cracked substrate is removed, which causes manufacturing yield to be lowered and adversely affects an entire manufacturing line.

Therefore, when the semiconductor wafer having the defect part such as the crack can be detected by the inspection apparatus and the inspecting method shown in the first embodiment and the like in an early stage of the manufacturing process of the semiconductor wafer, the manufacturing equipment is prevented from being adversely affected, that is, stopped during the manufacturing process by excluding such defective substrate and not performing subsequent process for that.

In addition, when the crack is inspected several times in each stage of the manufacturing process, an equipment trouble due to the crack of the substrate may be prevented.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

1. An infrared inspection apparatus comprising:
an infrared light source operable to irradiate an inspection object with infrared rays;
an infrared lens operable to collect infrared rays which have passed through the inspection object;
an infrared camera operable to receive the infrared rays collected by the infrared lens and to convert the infrared rays received into an electric signal to be output;
a monitor operable to receive the electric signal from the infrared camera to convert the electric signal into an image signal, and to display an image based on the image signal; and
an infrared ray leakage preventing member located in at least one of a light path between the infrared light source and a periphery of the inspection object and a light path between the periphery of the inspection object and the infrared lens to prevent infrared rays from the infrared light source from reaching the infrared lens without passing through the inspection object.

2. The infrared inspection apparatus according to claim 1, wherein the infrared ray leakage preventing member comprises a guide in contact with the periphery of the inspection object.

3. The infrared inspection apparatus according to claim 1, wherein the infrared ray leakage preventing member comprises a slit located in the light path between the infrared light source and the periphery of the inspection object.

4. The infrared inspection apparatus according to claim 1, wherein the infrared ray leakage preventing member is a material which does not transmit infrared rays.

5. The infrared inspection apparatus according to claim 1, wherein the infrared ray leakage preventing member is softer than the inspection object.

6. An inspecting method using an infrared inspection apparatus, comprising:
irradiating an inspection object with infrared rays from an infrared light source;
collecting infrared rays which have passed through the inspection object with an infrared lens;
blocking off at least one of a light path between the infrared light source and a periphery of the inspection object and a light path between the periphery of the inspection object and the infrared lens to prevent infrared rays from the infrared light source from reaching the infrared lens without passing through the inspection object,
receiving the infrared rays collected by the infrared lens and converting the infrared rays received into an electric signal to be output;
receiving the electric signal and converting the electric signal into an image signal;
displaying an image based on the image signal; and
determining a defective part and a non-defective part of the inspection object based on the image.

7. A method of manufacturing a semiconductor wafer using an infrared inspection apparatus, comprising:
irradiating a semiconductor wafer with infrared rays from an infrared light source;
collecting infrared rays which have passed through the semiconductor wafer with an infrared lens;
blocking off at least one of a light path between the infrared light source and a periphery of the semiconductor wafer and a light path between the periphery of the semiconductor wafer and the infrared lens to prevent infrared rays from the infrared light source from reaching the infrared lens without passing through the semiconductor wafer,
receiving the infrared rays collected by the infrared lens and converting the infrared rays received into an electric signal to be output;
receiving the electric signal from the infrared camera and converting electric signal into an image signal;
displaying an image based on the image signal; and
determining a defective part and a non-defective part of the semiconductor wafer based on the image to prevent equipment trouble, due to a crack in the semiconductor wafer.
